(19) United States
(12) Patent Application Publication
(10) Pub. No.: US 2009/0284712 A1
(43) Pub. Date: Nov. 19, 2009

(54) EYEGLASS SUPPORT DEVICE

(76) Inventor: Phillip E. Brooks, Peachtree City, GA (US)

Correspondence Address: Innovative IP, LLC, P.O. Box 217, New Smyrna Beach, FL, 32170, US

(21) Appl. No.: 12/465,117

(22) Filed: May 13, 2009

Related U.S. Application Data
(60) Provisional application No. 61/053,124, filed on May 14, 2008.

(51) Int. Cl. G02C 3/02; G02C 3/00

(52) U.S. Cl. 351/155

(57) ABSTRACT

An eyeglass support device for retrofit of consumer-selected articles, wherein a user can essentially select any bodyworn article for conversion, wherein a user can quickly, easily, and securely attach the eyeglass support device to the article in a desired position, wherein the device functions to effectively support eyeglasses in a secure manner on the user, and wherein the device is designed to be adaptably configured for accommodation of essentially any desirable logo or symbol, therefore allowing not only utilization as an advertising tool, but as a means for enabling the user to convey a personal message through the wear and display thereof.

### CROSS-REFERENCE AND PRIORITY CLAIM TO RELATED APPLICATION

To the fullest extent permitted by law, the present U.S. Non-Provisional patent application claims priority to and the benefit of U.S. Provisional Patent Application entitled “Eyeglass Support Device,” filed on May 14, 2008, on behalf of inventor Phillip E. Brooks, and having assigned Ser. No. 61/053,124.

### FIELD OF THE INVENTION

The present invention relates generally to eyeglass supports, and more particularly, to a device for retrofit affixing to bodyworn articles and for supporting eyeglasses.

### BACKGROUND OF THE INVENTION

Eyeglasses are invaluable to those who rely upon them daily in order to participate in normal activities. Even individuals that utilize glasses for only limited purposes, such as for reading or for clearly discerning distant objects, appreciate the benefits to their vision. However, especially for the occasional or intermittent wearer, eyeglasses can be perceived as a burden, especially during periods of non-use wherein the owner must carry or otherwise transport the glasses.

Typically, a specialized carrying case is provided upon purchase of a pair of eyeglasses. Such cases are designed to be structurally protective, along with lined interiors to prevent lens scratching. While effective, the size and shape of most such cases disadvantageously prohibits fit or comfortable transport in a pocket, and even in many small purses. As a result, many individuals simply carry their eyeglasses loose in their pocket or purse.

This risky choice is especially prevalent for sunglasses, wherein intermittent wear is the norm. Because sunglass wearers are necessarily out of doors, typically they are engaged in some sort of activity. It is these activities that frequently inhibit the carriage of a case. Therefore, if the wearer ventures indoors and removes the sunglasses, the sunglasses are oftentimes placed on a table where they may be forgotten. A further example is if the weather becomes clouded, such as during an outdoor spectator event, sunglass wearers frequently remove their glasses and either place them on their heads or hang them on their shirt collar. Both habits can result in inadvertent loss of the sunglasses because they remain loosely in place and at risk from movements of the wearer.

Attempts have been made to remedy the issues surrounding eyeglass storage and transport, but each is disadvantageous in view of the present invention. One popular option for storing and transporting eyeglasses is the use of a necklace or cord secured to the ends of the arms of the glasses. While such neckworn devices can be effective in preventing inadvertent loss of eyeglasses, these devices can be bothersome and even dangerous during some outdoor activities because swinging movement about the neck remains and the cords could catch on something, such as a tree branch or the like. Another option that has been proposed is the formation of specialized headwear, wherein a variety of receptacles have been defined for receiving the arms of glasses, either folded or unfolded, for secure carriage on the head. Each, however, disadvantageously limits the user's selection of headwear design. That is, only those specially manufactured hats and/or specially adapted sunglasses for cooperative association therewith may be selected by a user who desires the benefits.

Therefore, it is readily apparent that there is a need for a device that allows easy adaptation of essentially any headwear or bodywear for effective support and transport of eyeglasses on a person during periods of non-wear, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing an eyeglass support device for retrofit of consumer-selected articles, wherein a user can essentially select any bodyworn article for conversion, wherein a user can quickly, easily, and securely attach the eyeglass support device to the article in a desired position, wherein the device functions to effectively support eyeglasses in a secure manner on the user, and wherein the device is designed to be adaptably configured for accommodation of essentially any desirable logo or symbol, therefore allowing not only utilization as an advertising tool, but as a means for enabling the user to convey a personal message through the wear and display thereof.

According to its major aspects and broadly stated, in its preferred form, the present invention is a device for supporting eyeglasses, such as on a hat, wherein a desirably shaped emblem defines an aesthetically appealing device structure and display face, and wherein selectively placed specialized adhesive enables iron-on attachment of the device on essentially any surface, such as on the sides of hat, in a manner that secures the device to the support surface yet allows for slidable entry of the arms of eyeglasses therebetween.

More specifically, the eyeglass support device of the present invention in its preferred form for use on headwear, is a pair of generally flat, design-styled elements with a rear surface imparted with adhesive characteristics, wherein those adhesive characteristics are strategically located on the rear surface according to the shape of the design element such that relevant support features may be secured to the outer surface of a hat through the use of an iron, yet in a manner that allows for at least some portion of the design element to remain unattached, in order that the arms of a pair of glasses may be slidably positioned through a pair of design-styled elements opposingly positioned on either side of a hat. According to the preferred configuration, the eyeglass support device is formed as a three-dimensional silhouette of a logo, wherein background design components of the logo are removed and the device surface is strikingly non-solid, with solid portions preferably defined as fine embroidery.

It is intended that the eyeglass support device of the present invention may be utilized to quickly and easily retrofit any hat, cap, visor or the like to support glasses. This enables a user to select any style of headwear that he or she finds desirable for use with the eyeglass support device, wherein the preferred silhouette structure of the device serves to accent the headwear while permitting the underlying design surface to show through. Additionally, it is further intended that the eyeglass support device of the present invention may be utilized to quickly and easily retrofit other bodyworn articles, such as, for exemplary purposes only, shirts, pants, backpacks, or any other selected personal article. The after-market adaptation of essentially any such pre-existing is thus facilitated.

Although the foregoing design-styled silhouette element is the preferred form for the present invention, the underlying concept of facilitating easy after-market adaptation for support of any eyeglasses on any selected bodywear article could be accomplished according to further embodiments. That is, one such embodiment could utilize a more generally shaped eyeglass support element, such as a trapezoid, wherein an outer layer and an inner layer could be provided with a tunnel therebetween. In such an embodiment, the generally flat and essentially solid rear surface of the inner layer could be infused with select adhesive properties in order to facilitate iron-on attachment to a fabric or other suitable surface, wherein the arms of a pair of eyeglasses would extend through the tunnel rather than between the support device and the support surface.

According to another embodiment, the eyeglass support device of the present invention could be configured to not only allow for after-market adaptation of essentially any hat or bodyworn support, but could further be configured for removability therefrom during periods of non-use. One manner of accomplishing such desirable features could be via the use of magnets. For example, the design-styled silhouette element previously described could be formed as a metallic and/or magnetized clip for removably secure attachment, such as to a cap. Specialized tips, such as elasticized tubes with incorporated metallic and/or magnetized features, could be provided for removably secure attachment to the arms of a pair of glasses, thereby enabling cooperative utilization of the adapted glasses and the adapted cap in a manner that allows for easy removal of the magnetic adaptations after the desired use is complete, wherein the same components may be selectively utilized in combination with a different hat or visor or glasses, as desired.

Thus, a feature and advantage of the present invention is its ability to be utilized to retrofit essentially any user-selected hat, cap, visor, shirt, pants, backpack, scarf, or the like.

Another feature and advantage of the present invention is its ability to function as an inexpensive and unique advertising tool, wherein corporate trademarks, collegiate logos, licensed characters, charitable emblems, or the like may be distributed and displayed by scores of wearers for a very minimal investment.

Another feature and advantage of the present invention is its ability to quickly and easily be securely fastened to a select item via strategically positioned on-board, iron-on adhesive, thus eliminating the necessity of sewing, and thereby facilitating the after-market installation thereof.

Yet another feature and advantage of the present invention is its ability to offer an embodiment for temporary retrofit adaptation, such as through the use of removable metal and/or magnetized components for removable placement on a pair of glasses and an article of bodywear.

Still another feature and advantage of the present invention is its ability to adaptively position for either singular or plural use depending upon the bodywear article.

Yet still another feature and advantage of the present invention is its ability to adaptively install for support of a pair of glasses in either an open or folded position, depending upon the selected positioning for use on the bodywear article.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a plan view of an eyeglass support device, according to the preferred embodiment of the present invention;

FIG. 2 is a perspective view of the eyeglass support device of FIG. 1, showing the device installed on a visor;

FIG. 3 is a perspective view of an eyeglass support device, according to an alternate embodiment of the present invention, showing the device installed on a cap;

FIG. 4A is a perspective view of an eyeglass support system, according to an alternate embodiment of the present invention, showing a cooperative magnetic element removably secured to the arms of a pair of sunglasses; and

FIG. 4B is a perspective view of an eyeglass support system, according to an alternate embodiment of the present invention, showing a cooperative metallic element for removable placement on an article of headwear.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

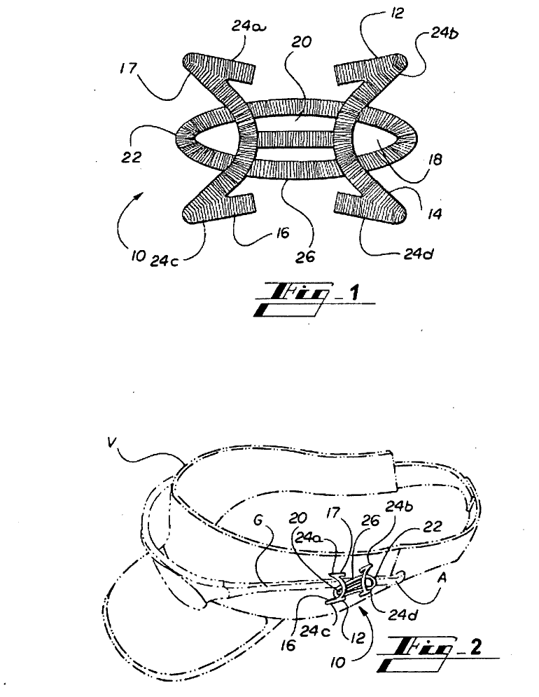

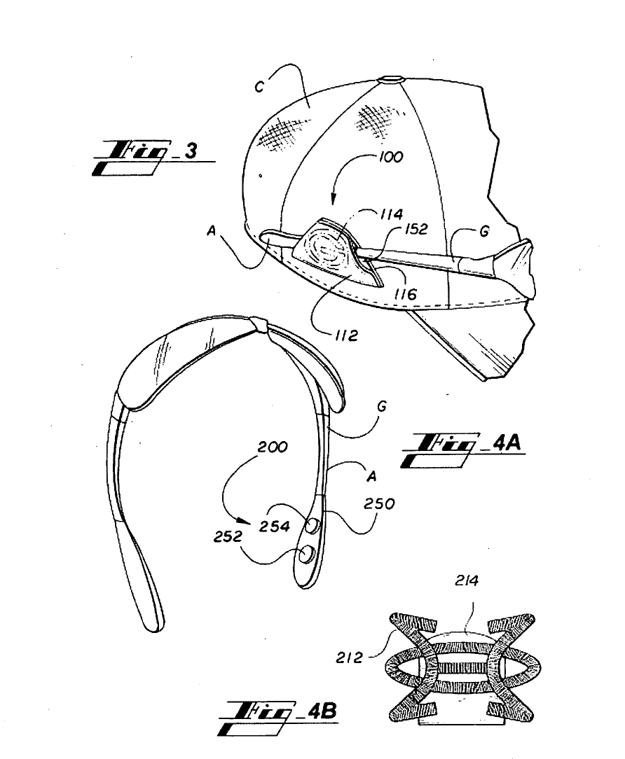

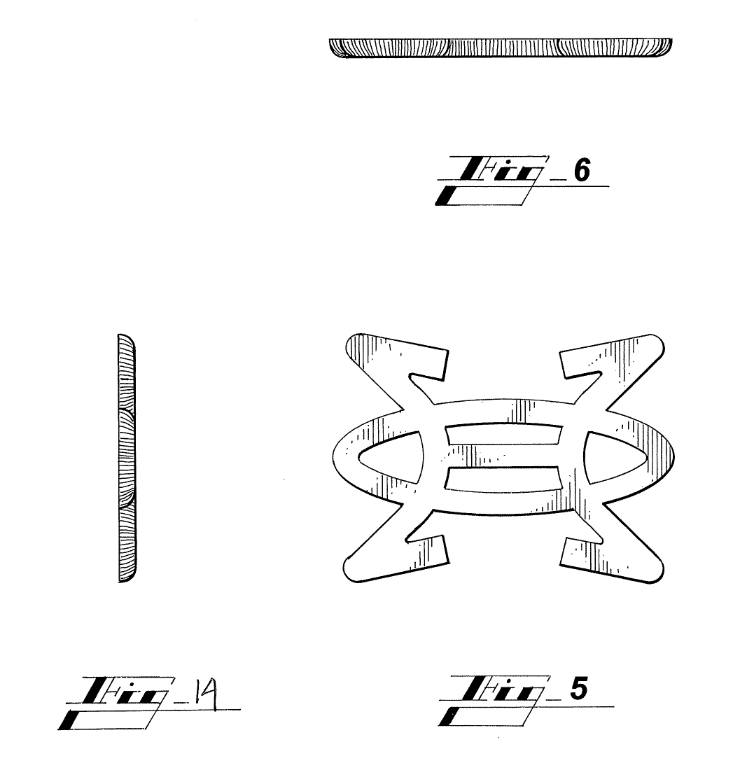

Referring now to FIGS. 1-3, the present invention, in the preferred embodiment, is system and device 10 for supporting eyeglasses on a bodyworn article, and the method of retrofit thereof to after-market consumerwear merchandise, providing easy adaptation of essentially any headwear or bodywear for effective support and transport of eyeglasses on a person during periods of non-wear. Preferably, eyeglass support device 10 comprises desirably shaped emblem 12, having an aesthetically appealing structural configuration and display face 14, wherein rear surface 16 is preferably endowed with specialized adhesive in selective zones in order to enable iron-on attachment of device 10 on essentially any surface, such as on the sides of visor V in FIG. 2, hat, in a manner that allows for slidable entry of the arms A of eyeglasses G therebetween.

In the preferred embodiment, the structural configuration of desirably shaped emblem 12 is derived from the preferred trademark logo of Hold On, LLC, as shown in FIGS. 1-2. As is preferred, eyeglass support device 10 is formed as a silhouette, with die-cut-style edges 17, wherein plurality of background design component spaces 18 are cut-out or otherwise empty, rendering surface 20 of emblem 12 strikingly non-solid, with plurality of solid portions 22 preferably defined as fine embroidery. It should be readily recognized that emblem 12 is designed and intended to be adaptably configured for accommodation of essentially any desirable logo or symbol, wherein plurality of background design component spaces 18 and plurality of solid portions 22 would be altered to result in the selected display. Therefore, while the following will be described, for convenience, with reference to the preferred trademark logo of Hold On, LLC, it should be expressly understood that any suitable emblem 12 could be alternately created, such as, for exemplary purposes only, corporate trademarks, collegiate logos, licensed characters, charitable emblems, personalized monograms, or the like.

Rear surface 16 is preferably coated, encrusted, layered, and/or otherwise at least partially covered with a specialized adhesive at attachment points 24a, 24b, 24c, 24d, positions of preferred application that are strategically located according to the peripheral shape of emblem 12 such that device 10 may be secured to the outer surface of a hat, for example, in a manner that allows for central body portion 26 to remain unattached, in order that the arm of a pair of glasses may be slidably positioned thereunder. Any known specialized adhesive may be utilized, wherein the relevant preferred characteristics include the ability for application, with subsequent consumer presentation in a non-tack or dry form, wherein further subsequent application of heat by the consumer results in activation of the adhesive layer and enable device 10 to be securely attached to a selected support surface. Alternately, similarly applied adhesive or other bonding agent may be applied to device 10, with consumer presentation in a tack form, wherein removable protective shielding may serve to cover the adhesive until installation of emblem 12 by the consumer.

As depicted in FIG. 2, device 10 is preferably utilized as a pair, with one emblem 12 attached on either side of a hat or visor, V, in order to accommodate respective arms A of sunglasses G. Although this is the preferred configuration for installation and use of device 10, it is further intended that device 10 may be similarly utilized to quickly and easily retrofit other bodyworn articles, such as, for exemplary purposes only, shirts, pants, backpacks, or any other selected personal article. In such applications, however, it may be desirable to utilize a single device 10, such as on a shirt, wherein it may be desirable to re-orient installation of device 10 in order to receive and support the arm of a pair of folded eyeglasses therewith.

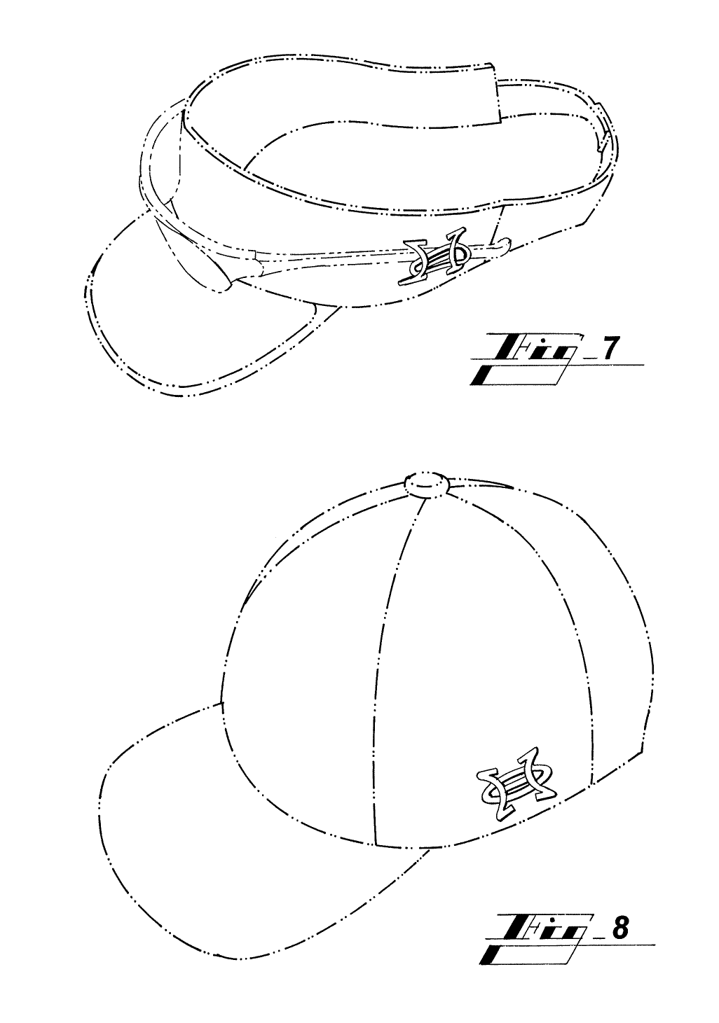

Although the foregoing design-styled silhouette element is the preferred form for the present invention, the underlying concept of facilitating easy after-market adaptation for support of any eyeglasses on any selected bodywear article could be accomplished according to further embodiments. One such embodiment is represented in FIG. 3, wherein device 100 is trapezoidal-shaped structure 112 with essentially solid display face 114, wherein essentially solid rear surface 116 is endowed with specialized adhesive, as described above, in order to enable iron-on attachment of device 100 on essentially any surface, such as on the sides of cap C. Outer layer 150 and inner layer 152 define tunnel 54, wherein arm A of sunglasses G may be slidably related therethrough. Therefore, this alternate embodiment allows for distribution of adhesive coating over a larger area defined by rear surface 116, still assembled to facilitate iron-on application to essentially any suitable personal article or bodywear, as desired by the user. It should be expressly understood that this embodiment, also, is suitable for display of any emblem 12 at display face 114, such as, for exemplary purposes only, corporate trademarks, collegiate logos, licensed characters, charitable emblems, personalized monograms, or the like.

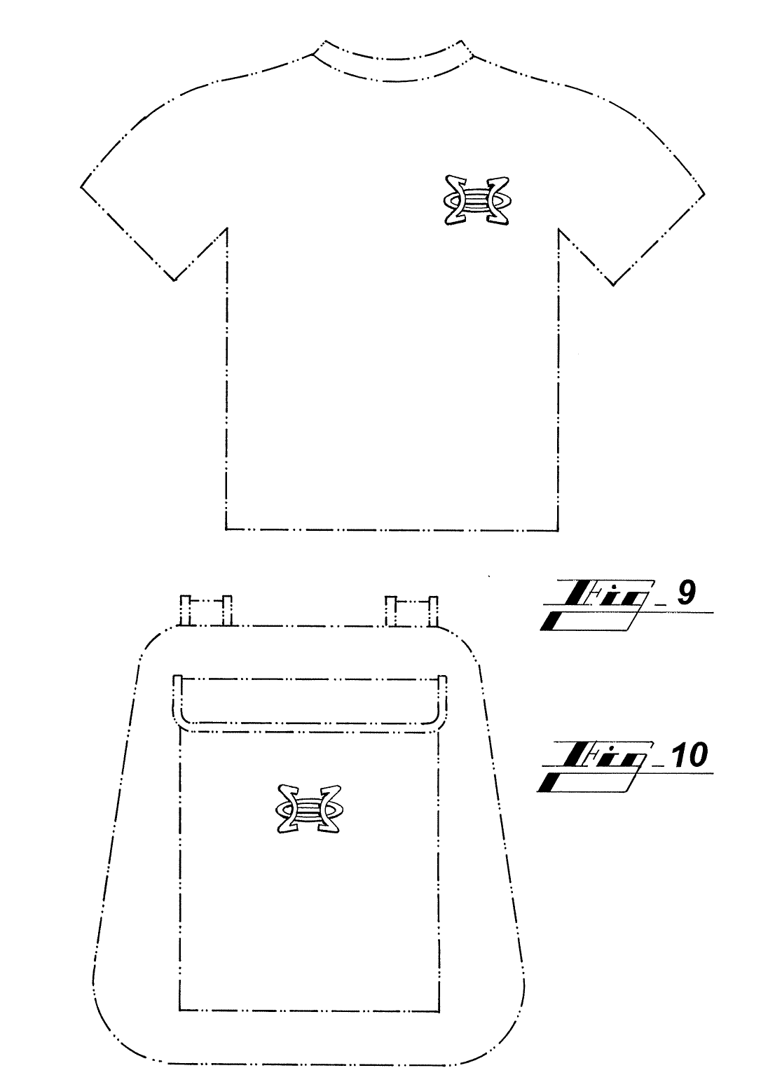

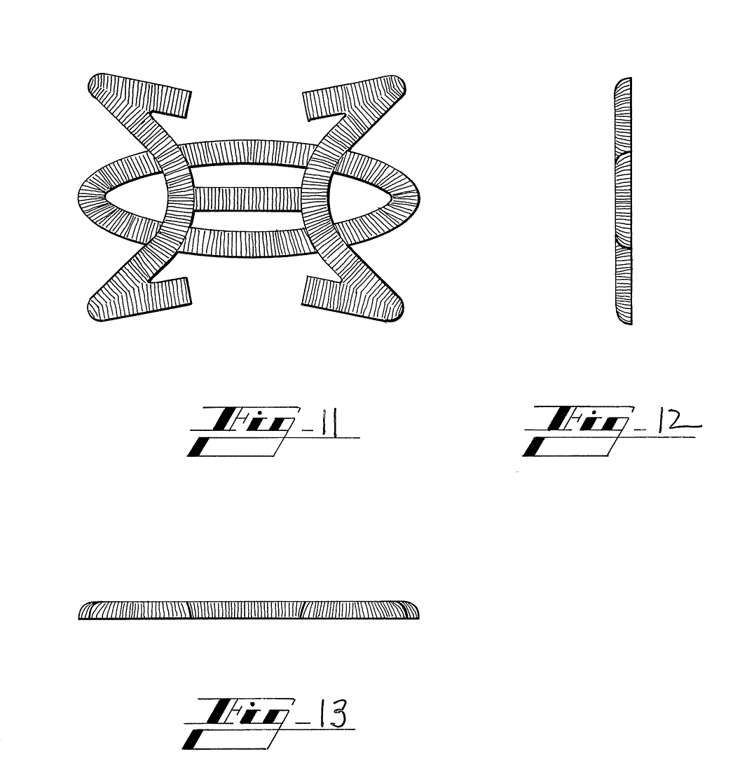

According to another embodiment, the method of after-market adaptation of essentially any hat or bodyworn personal article for support of eyeglasses could further be configured to facilitate removal of such adaptation from the hat or bodyworn personal article during periods of non-use. With reference to FIGS. 4A and 4B, system 200 for eyeglass support is shown. Specifically, design-styled silhouette element 212 could be formed as clip 214, wherein clip 214 may be metal and/or imparted with magnetic properties, and wherein clip 214 is configured to removably and securely attach, such as to a cap, by frictional, slidable engagement, or other suitable, removable method of attachment. Coincident therewith, specialized tips 250, such as elasticized tubes 252 with incorporated metallic and/or magnetized features 254, could be provided for removably secure attachment to the arm A of a pair of glasses G, thereby enabling cooperative utilization of the adapted glasses G and an adapted cap in a manner that allows for easy removal of the magnetic adaptations after the desired use is complete, wherein the same components, clip 214 and tips 250 may be selectively utilized in combination with a different hat or visor or glasses, as desired.

Accordingly, the easy adaptability of the present invention is an improved advertising tool, wherein a targeted logo may be inexpensively formed, with distribution of device 10 as a valuable marketing tool or giveaway that will be worn and viewed by many, without necessitating the underwriting of the cost of the hat or shirt by the advertiser. The present invention also serves as a means for enabling a user to communicate a message of support by selection and installation of an emblem of his or her choosing, such as representing a charitable organization, college, or the like, or by choosing a personalized monogram silhouette or the like.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A device for supporting eyeglasses, comprising:
a silhouette emblem for attachment to a selected personal article; and
an adhesive carried in selected zones on a rear surface said silhouette emblem, said zones selected proximate the peripheral edge of said emblem, wherein heat-activation of said adhesive enables attachment of said emblem to the selected personal article with a central portion of said emblem remaining unattached.

2. A device for supporting eyeglasses, comprising:
a trapezoidal-shaped structure with an outer layer having a display face and an inner layer having a rear surface;
an adhesive carried on said rear surface, wherein said adhesive facilitates iron-on attachment of said device to a hat, and wherein a tunnel is defined between said outer layer and said inner layer.

3. A system for removable adaptation of an article of headwear and a pair of glasses, comprising:
a first and second clip, each said clip dimensioned for friction fit proximate the bottom rim of a cap, and each said clip imparted with magnetic properties; and
a first and second tip, each said tip further comprised of an elasticized tube with incorporated magnetic properties, and each tip dimensioned for slidably secure fit proximate the arm of a pair of eyeglasses,
wherein said first clip and said first tip could magnetically adhere, and wherein said second clip and said second tip could magnetically adhere.
